(19) United States
(12) Patent Application Publication
(10) Pub. No.: US 2006/0246368 A1
(43) Pub. Date: Nov. 2, 2006

(54) Master batch and toner using the same

(76) Inventors: Katsuru Matsumoto, NARA (JP); Sayaka Fujita, Nara (JP); Masahiro Sakai, Osaka (JP); Toshihiko Murakami, Nara (JP); Mitsuhiro Toyoda, Nara (JP)

Correspondence Address: BIRCH STEWART KOLASCH & BIRCH, PO BOX 747, FALLS CHURCH, VA, 22040-0747, US

(21) Appl. No.: 10/538,015

(22) PCT Filed: Jan. 22, 2004
(86) PCT No.: PCT/JP04/00542

§ 371 Date: Jun. 7, 2005

(30) Foreign Application Priority Data
Jan. 24, 2003 (JP) 2003-016491

(51) Int. Cl. G03G 9/09; C08J 3/22

(52) U.S. Cl. 430/109.2; 430/109.4; 523/351; 524/599

(57) ABSTRACT

This invention provides masterbatch (MB) comprising at least a colorant and polyester resin, wherein the glass transition temperature (Tg) and the softening point (Sp) of such polyester resin satisfy the correlations defined by formulae (1) and (2): 4Tg−170≦Sp≦4Tg−110 (1); and 90≦Sp≦120 (2), and toner using such masterbatch. The toner prepared from such masterbatch comprising base resin having excellent heat resistance and good dispersibility can produce images having stable and even glossiness, brilliant color, and a wide fusing temperature range.

### TECHNICAL FIELD

The present invention relates to masterbatch (resin with strong coloring power) and toner using the same.

### BACKGROUND ART

A method that has been heretofore extensively employed for coloring thermoplastic resins black involves compounding powdery or particulate carbon black into powders of resin or a resin composition, pellets, or a mixture of pellets and powders, melt-kneading the resultant in an extruder, and extruding the kneaded product, followed by pelletizing thereof.

Such method wherein carbon black powders are compounded in such a state into resin or a resin composition, however, has been problematic in terms of, for example, contamination of the work environment with fine particles, handling, generation of air bubbles of carbon black due to classification, aggregation, or the like, the existence of a color remaining in a subsequent lot, and color mixing.

A method involving the use of masterbatch (MB) prepared by compounding carbon black in resin is employed. Polystyrene resins that are highly compatible with carbon black are often used for carbon black masterbatch.

Masterbatch composed of general polystyrene, AS, or other resin is used in a temperature range that exceeds the heat-resistant temperature of resins in the masterbatch. This disadvantageously results in deteriorated physical properties of resin compositions comprising masterbatch, lowered heat resistance, generation of gas at the time of molding, and increased mold deposits (substances adhering to the mold). Accordingly, masterbatch composed of base resin having excellent heat resistance and good dispersibility has been awaited.

Carbon black is highly aggregative and reaggregation, which is generally referred to as a “structure,” has occurred therein. Thus, a fluid with a high carbon black content shows thixotropy. Masterbatch with a high carbon black content has similar properties. In general, such masterbatch is significantly less likely to flow compared to base resin.

When the melt viscosity of the base resin is low, accordingly, dispersion of resins that constitute the masterbatch is insufficient, which often results in generation of “air bubbles” in the molded products. This phenomenon becomes more significant in the case of carbon black with a high degree of blackness, where a coal black color is exhibited.

JP Patent Publication (Kokai) No. 61-236854 A (1986) discloses carbon black masterbatch comprising a high-molecular-weight aromatic polycarbonate similar to base resin without the use of styrene resins for masterbatch.

Regarding the masterbatch comprising such high-molecular-weight resins, however, relatively good masterbatch can be obtained when carbon black with a relatively low degree of blackness and good dispersibility is used. In contrast, it is difficult to obtain good masterbatch for coloring having carbon black evenly dispersed therein when carbon black has a high degree of blackness, insufficiently developed structure, or small average primary particle size.

In the case of a developing method involving the use of a nonmagnetic single-component developer, in general, chargeability must be imparted to the toner via contact between thinly-layered toner and developing sleeves, elastic blades, or the like. Thus, mechanical stress imposed on the toner is particularly strong, and toner often becomes aggregated or solidified due to friction heat generated during the continuous use thereof. Such phenomenon induces fusion of toner aggregates to developing sleeves or elastic blades in the end, which produces images with fatal defects.

### DISCLOSURE OF THE INVENTION

A technique was proposed in order to overcome such drawbacks. In such a technique, surfaces of toner particles are coated with external additives such as fine silica particles to render toner particles nonadhesive. This has helped to overcome problems such as particle aggregation. Since this technique involves agitation in a developing machine for a long period of time, it involves problems such as dropping or scattering of fine particles of external additives from the toner surface or embedding thereof in toner particles. Thus, the toner obtained via such technique is insufficient in terms of its durability since the initial properties cannot be maintained. It has been considered necessary to improve the nonmagnetic single-component toner primarily in terms of properties of toner binder resins. Therefore, a fundamental solution has been heretofore desired concerning such problems.

The present invention is directed at providing masterbatch comprising base resin with excellent heat resistance and good dispersibility and toner having properties shown below.

(a) Toner aggregation is less likely to occur.

(b) Toner is unlikely to become fused to a photoconductor, a developing sleeve, an elastic blade, or the like.

(c) Toner has good fluidity and high transferability.

(d) Toner is less likely to become aggregated or fused under high-temperature or high-humidity conditions.

(e) Toner offset does not occur at the time of fusing and the fusing strength is high.

(f) Image quality is not significantly changed, even after continuous or long-term use.

Accordingly, the present invention is directed at providing toner having excellent temporal stability and durability.

Such goal can be attained with the use of masterbatch comprising polyester resins with specific thermal properties.

More specifically, the first aspect of the present invention relates to the masterbatch described in (1) and (2) below and the second aspect of the present invention relates to the toner described in (3) to (10).

(1) Masterbatch (MB) comprising at least a colorant and polyester resin, wherein the glass transition temperature (Tg) and the softening point (Sp) of the polyester resin satisfy the correlations defined by formulae (1) and (2):
4Tg−170≦Sp≦4Tg−110 (1); and
90≦Sp≦120 (2).

(2) The masterbatch (MB) according to (1), wherein the storage modulus (G′) at 100° C. is 10E+3 or higher and the ratio of a colorant to resin is between 25:75 and 55:45.

(3) Toner using the masterbatch according to (1) or (2).

(4) The toner according to (3) comprising polyol resins synthesized via reactions of crystalline polyester resins having a softening point of 80° C. to 150° C., epoxy resins (a), dihydric phenol (b), and an alkylene oxide adduct of dihydric phenol or a glycidyl ether compound thereof (c), having a polyoxyalkylene moiety in its main chain, and having the ratio of the weight average molecular weight (Mw) to the number average molecular weight (Mn) of 4 to 10.

(5) The toner according to (4), wherein the polyol resins comprise 10 to 40 parts by weight of component (c) based on the total amount thereof (100 parts by weight).

(6) The toner according to (4) or (5), wherein component (a) is comprised of at least 2 types of bisphenol epoxy resins having different number average molecular weights (Mn).

(7) The toner according to any one of (4) to (6), wherein the epoxy equivalent weight of the polyol resins is 20,000 or higher.

(8) The toner according to any one of (4) to (7), wherein the softening point of the polyol resins is between 115° C. and 13° C.

(9) The toner according to any one of (4) to (8), wherein the amount of component (c) is 10 to 50 parts by weight based on 100 parts by weight of component (a) in polyol resins.

(10) The toner according to any one of (4) to (9), wherein the melting point of a mold-releasing agent contained in the toner is between 70° C. and 120° C.

### BEST MODES FOR CARRYING OUT THE INVENTION

Hereafter, the elements of the present invention are described in detail.

The masterbatch (MB) according to the present invention is comprised of at least a colorant and polyester resin.

Any suitable pigments or dyes are used as colorants that are contained in the masterbatch according to the present invention. Any conventional dyes and pigments, such as carbon black, lampblack, iron black, ultramarine blue, aniline blue, phthalocyanine blue, phthalocyanine green, Hansa yellow G, rhodamine dyes and pigments, chrome yellow, quinacridon, benzidine yellow, rose bengal, triarylmethane dyes, anthraquinone dyes, and monoazo and disazo dyes and pigments can be used alone or in combinations of two or more.

Commercialized carbon black for coloring can be used. Specifically, carbon black, which is used when a relatively high degree of blackness is required, has an average primary particle size of 10 μm to 24 μm, has a poorly-developed structure, and exhibits oil absorption of 100 ml/100 g or lower, can be employed.

The surface pH level of carbon black is somewhat alkaline, neutral, or acidic. Since polyesters have low tolerance for alkali, carbon black having a neutral or acidic surface pH level is employed. In the present invention, carbon black having a surface pH level of 3 to 8 is preferable, and that having a surface pH level of 4 to 7 is particularly preferable.

In the present invention, the carbon black content in the masterbatch is 20% to 75% by weight thereof. When the carbon black content is lower than 30% by weight, homogenous dispersion of carbon black in an oligomer as a base resin may sometimes be difficult. In such a case, masterbatch comprising 30% by weight or more carbon black is prepared, and a desired amount of base resin is added thereto in order to bring the carbon black content to a desired level via kneading. As the carbon black content in the masterbatch is increased, the viscosity of the masterbatch is heightened, which tends to deteriorate homogenous dispersion of carbon black in base resin. Accordingly, an excessively high carbon black content in the masterbatch is not preferable. Thus, the carbon black content in the masterbatch is preferably 30% to 60% by weight of the total amount of the masterbatch.

The masterbatch for coloring according to the present invention can be obtained via a variety of mixing techniques. An example of such technique is a method wherein base resin powders or pellets of the masterbatch are mixed with carbon black as a coloring pigment using a tumbler, super mixer, or other means, and the resulting mixture is pelletized or coarsely grained using a kneader such as an extruder or a Banbury mixer via melt-kneading.

During the production of the masterbatch, a charge control agent and other additives may be dispersed therein together with a colorant.

Polyester resins that are used in the present invention are composed of polyalcohols and polybasic acids, and such resins are obtained via polymerization of monomer compositions comprising polyalcohols and polybasic acids, at least one of which comprises trihydric or higher multifunctional components (crosslinking components) according to need.

Examples of dihydric alcohols that are used for synthesizing polyester resins include bisphenol A, hydrogenated bisphenol A, polyoxyethylenated bisphenol A, and an alkylene oxide adduct of bisphenol A such as polyoxypropylenated bisphenol A. Among these monomers, use of an alkylene oxide adduct of bisphenol A is preferable as a primary monomer component. An adduct having an average number of alkylene oxide adducts of 2 to 7 per molecule is particularly preferable.

Examples of polyalcohol having three or more hydroxyl groups that are involved with crosslinking of polyesters include sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of polybasic acids include maleic acids, fumaric acids, citraconic acids, itaconic acids, glutaconic acids, phthalic acids, isophthalic acids, terephthalic acids, cyclohexane dicarboxylic acids, succinic acids, adipic acids, sebacic acids, azelaic acids, malonic acids, the anhydrides thereof, lower alkyl ester, alkenyl succinic acids or alkyl succinic acids such as n-dodecenylsuccinic acids or n-dodecylsuccinic acids, and other divalent organic acids.

Examples of polybasic acids having three or more hydroxyl groups that are involved with crosslinking of polyesters include 1,2,4-benzenetricarboxylic acids, 1,2,5-benzenetricarboxylic acids, 1,2,4-cyclohexane tricarboxylic acids, 2,5,7-naphthalenetricarboxylic acids, 1,2,4-naphthalenetricarboxylic acids, 1,2,5-hexanetricarboxylic acids, 1,3-dicarboxyl-2-methyl-2-methylenecarboxy-propane, tetra(methylenecarboxyl)methane, 1,2,7,8-octanetetracarboxylic acids, and the anhydrides thereof.

Such polyester resins can be synthesized in accordance with a conventional technique. Specifically, conditions such as a reaction temperature of 170° C. to 250° C. and a reaction pressure of 5 mmHg to normal pressure are determined in accordance with monomer reactivity, and the reaction may be terminated when the given level of physical properties are attained. As mentioned above, polyester resins having softening points (Sp) and glass transition temperatures (Tg) in the ranges represented by the equations (1) and (2) are used.

The softening points (Sp) of polyester resins that are used in the present invention are between 90° C. and 120° C. For example, the glass transition temperature (Tg) is between 50° C. and 65° C. when the softening point is 90° C. and it is between 60° C. and 75° C. when the softening point is 130° C. Sp and Tg outside the aforementioned ranges are not preferable. For example, when Sp is lower than the lower limit of the aforementioned range, toner offset is likely to occur at the time of fusing. When Sp is higher than the upper limit, fusing energy is increased and the glossiness and transparency of color toners tend to be deteriorated. When Tg is lower than the lower limit, toner aggregation or fusing is likely to occur. When Tg is higher than the upper limit, the fusing strength tends to be deteriorated at the time of thermal fusing. Sp and Tg outside the ranges represented by equations (1) and (2) are not practical in terms of the correlation between the conditions for producing the masterbatch and the carbon black (CB) content (a higher CB content is preferable). Sp can be primarily regulated by the resin molecular weight, and the number-average molecular weight is preferably in the range of 2,000 to 20,000 and more preferably in the range of 3,000 to 12,000.

Tg can be regulated by adequately selecting a primary monomer component of resin. Specifically, Tg can be increased by selecting an aromatic polybasic acid as a primary acid component. Among the aforementioned polybasic acids, use of phthalic acid, isophthalic acid, terephthalic acids, 1,2,4-benzenetricarboxylic acid, 1,2,5-benzenetricarboxylic acid, the anhydrides thereof, lower alkyl ester, or the like as a primary component is preferable.

Sp of polyester resins is measured using flow testers as indicated in JIS K 7210 and K 6719. Specifically, measurement is carried out using a flow tester (CFT-500, Shimadzu Corporation) in the following manner. A sample (about 1 g) is heated at a temperature-rise rate of 3° C. per minute, a load of 30 kg/cm² is applied thereto using a plunger with an area of 1 cm², and the sample is then extruded from a die having a pore diameter of 1 mm and a length of 10 mm. A plunger stroke-temperature curve is drawn based thereon, the height of the S-curve is determined to be “h,” and the temperature that is equivalent to “h/2” is determined to be the softening point.

Tg of polyester resins is then measured using DSC-200 (Seiko Instruments Inc.) in the following manner. At the outset, samples are comminuted, 10±1 mg thereof is weighed and placed in an aluminum sample container, and an aluminum lid is crimped thereon. The glass transition temperature (Tg) is measured by the DSC method in a nitrogen atmosphere. DSC measurement is performed under the following conditions. Samples are heated from room temperature to 150° C. at a temperature-rise rate of 20° C. per minute, allowed to stand at 150° C. for 10 minutes, cooled to 0° C. at a temperature-fall rate of 50° C. per minute, allowed to stand at that temperature for 10 minutes, and then heated again to 150° C. at a temperature-rise rate of 20° C. per minute under a nitrogen atmosphere (20 cc/min). Concerning Tg, the peak kickoff temperature is read using Tg Job analyzing software.

When polyester resins have excessively high acid values, it is generally difficult to attain stable and high-level electrification, and electrification stability under high-temperature and high-humidity conditions tends to be deteriorated. In the present invention, polyester resins are preferably prepared to have an acid value of 50 KOHmg/g or lower and more preferably 30 KOHmg/g or lower. Any methods for regulating the acid value within the aforementioned ranges can be carried out in accordance with conventional techniques without particular limitation. Examples of such techniques include a method that involves regulation of the amount of alcohol and acid monomers to be added at the time of resin synthesis, a method wherein resins are synthesized using a lower alkyl esterification product of an acid monomer component via transesterification, and a method that involves neutralization of remaining acid groups with the addition of a basic component such as amino-containing glycol to the composition.

Acid values of polyester resins are measured in accordance with the method as indicated in JIS K 0070. When it is difficult to dissolve resins in a solvent, however, a good solvent such as dioxane may be used.

Other conventional resins may be mixed with resins for the toner resins according to the present invention within the scope of the present invention. Examples of other resins include polyester resins that are outside the scope of the present invention, styrene acrylic resins, epoxy resins, butyral resins, and styrene butadiene resins.

In the present invention, it is necessary to incorporate crystalline polyester resins having a softening point of 80° C. to 150° C. in toner in order to improve the fusing properties thereof. The amount to be incorporated is 5 to 30 parts by weight based on 100 parts by weight of binder resins. Resins having the softening point lower than 80° C. are not preferable since they easily cause developer aggregation (soft caking). Resins having a softening point higher than 150° C. are not preferable since they raise the cold offset temperature. The same applies to the amounts of resins to be incorporated. An excessive amount results in elevated developer aggregation, and fusing properties cannot be improved if the amount is too small.

Polyol resins that are used in the present invention refer to polyether polyol resins having epoxy backbones. The ratio of the weight average molecular weight to the number average molecular weight (Mw/Mn) of polyol resins is preferably between 4 and 10. When “Mw/Mn” representing the molecular weight distribution is smaller than 4, toner offset is likely to occur with the use of a simple fusing apparatus of an oil-coating type, such as an oil-coating roller or oil-coated felt, and a temperature range sufficient for fusing cannot be substantially attained. When Mw/Mn is larger than 10, sufficient glossiness or color development of an image cannot be attained, and thus, the effects intended by the present invention cannot be achieved. Thus, Mw/Mn is preferably between 4 and 10 and it is more preferably between 5 and 8. Use of a polyol resin having a polyoxyalkylene moiety in its main chain can improve glossiness. Such polyoxyalkylene moiety in the main chain is identified by NMR.

The polyol resin according to the present invention is produced in the following manner. An example of an epoxy resin (a) used for producing the polyol resin is one obtained by a condensation reaction between bisphenol A or bisphenol F and epichlorohydrin resin. An adequate molecular weight distribution can be attained via synthesis of polyol resins with the use of at least two types of bisphenol A epoxy resins having different number-average molecular weights. This enables provision of toner having a wide fusing temperature range and an image having stable glossiness, which is the second object of the present invention. In this case, the number-average molecular weight of a low-molecular weight component is preferably in the range of 360 to 2,000 and that of a high-molecular weight component is preferably in the range of 3,000 to 10,000. Examples of dihydric phenol (b) include a bisphenol compound such as bisphenol A or bisphenol F.

Examples of an alkylene oxide adduct of dihydric phenol, which is the component (c) used for synthesizing the polyol resins, include reaction products of alkylene oxides such as ethylene oxide, propylene oxide, butylene oxide, or a mixture thereof with a bisphenol compound such as bisphenol A or bisphenol F. The resulting adduct may be further reacted with epichlorohydrin or β-methylepichlorohydrin to prepare a glycidyl ether compound thereof.

When the alkylene oxide adduct of dihydric phenol (component (c)) or a glycidyl ether compound thereof is compounded in the polyol resins in amounts of 10% to 50% by weight based on epoxy resins (component (a)), toner having glossiness and capable of forming brilliantly colored images can be obtained, which is the first object of the present invention. Further, the second object, i.e., the provision of toner having a wide fusing temperature range and an image having stable glossiness, and the third object, i.e., an image having uniform glossiness, are attained. When the amount thereof is smaller than 10% by weight, the effect of addition cannot be attained. Amounts larger than 50% by weight may occasionally produce adverse influences such as generation of excessive gloss or reduction in shelf life. A shortage of glycidyl ether in the polyol may cause defects such as curling. An excessive amount thereof may result in excessive glossiness or reduced shelf life. Diglycidyl ether of alkylene oxide adducts of bisphenol A represented by formula (1) is particularly preferable:

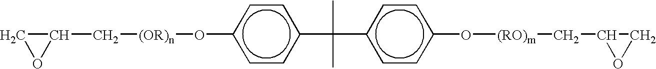

wherein R represents —CH₂—CH₂—, —CH₂CH(CH₃)—, or —CH₂—CH₂—CH₂—; n and m are each independently 1 or larger; and the sum of n+m is between 2 and 8.

When the sum of n+m exceeds 8, it may result in elevated developer aggregation or reduction in shelf life.

The amounts of the components (a), (b), and (c) are preferably 25 to 70 parts by weight, 10 to 40 parts by weight, and 15 to 40 parts by weight, respectively.

The polyol resins are prepared to contain no epoxy group and to have an epoxy value of 20,000 or higher. Use of such resins can produce excellent sensitizing properties and stability at the time of production. More specifically, an epoxy group at the terminus may be further reacted with monohydric phenol or excessive amounts of dihydric phenol compounds. Examples of monohydric phenols that are allowed to react with the epoxy group include phenol, cresol, isopropylphenol, amylphenol, nonylphenol, dodecylphenol, xylenol, and p-cumylphenol. Examples of the aforementioned dihydric phenol include bisphenol compounds such as bisphenol A and bisphenol F. A polyol resin softening point between 115° C. and 130° C. is sufficient to achieve the second object of the present invention, i.e., provision of toner having a wide fusing temperature range and an image having stable glossiness. When the softening point is lower than 115° C., it is difficult to attain a sufficient fusing temperature range. When it exceeds 130° C., however, formation of an image having sufficient glossiness tends to be difficult.

Further, if the polyol resins comprise 10 to 40 parts by weight of an alkylene oxide adduct of dihydric phenol or a glycidyl ether compound (c) thereof based on 100 parts by weight of the synthesized polyol resins, the first object of the present invention, i.e., toner that can produce glossy and brilliantly-colored images, the second object, i.e., toner having a wide fusing temperature range and an image having stable glossiness, and the third object, toner that can produce an image having uniform glossiness, can be attained. When the amount is less than 10 parts by weight, problems such as curling may occur. When the amount exceeds 40 parts by weight, developer is likely to aggregate and shelf life may be reduced.

The polyol content based on 100 parts by weight of binder resins is preferably between 5 and 40 parts by weight in order to optimize developer aggregation and hot offset resistance.

In the present invention, a mold-releasing agent softening point between 70° C. and 120° C. is sufficient to obtain toner having excellent shelf life. A softening point lower than 70° C. is likely to result in a coarse surface and deteriorated glossiness of the image as well as reduced shelf life. In contrast, a softening point higher than 120° C. is also problematic in terms of image quality, such as resulting coarse surfaces and deteriorated glossiness.

Specific examples of the mold-releasing agent include: synthetic waxes of low-molecular weight polyethylene, polypropylene, and a copolymer thereof; plant waxes such as candelilla wax, carnauba wax, rice wax, Japan tallow, and jojoba wax; animal waxes such as beeswax, lanoline, and spermaceti wax; mineral waxes such as montan wax and ozokerite; and oil waxes such as hydrogenated castor oil, hydroxy stearic acid, fatty acid amide, and phenolic fatty acid ester. Waxes can be classified in terms of their chemical structures, and hydrocarbon waxes, ester waxes, amide waxes, and the like are known. Among them, ester waxes are suitable in terms of shelf life, image quality, fusing temperature range, and the like.

The amount of the mold-releasing agent is preferably 1 to 6 parts by weight based on the total amount of the toner. When the amount exceeds 6 parts by weight, problems, such as storage stability, a coarse image surface, and deteriorated glossiness, may occur. In contrast, the image surface tends to be coarse when the amount is lower than 1 part by weight, which in turn results in poor image quality.

Subsequently, other materials used for the toner according to the present invention are described.

Any conventional dyes and pigments can be used as colorants. Examples thereof include carbon black, nigrosine dye, iron black, naphthol yellow S, Hansa yellow (10G, 5G, G), cadmium yellow, iron oxide yellow, ocher, chrome yellow, titanium yellow, polyazo yellow, oil yellow, Hansa yellow (GR, A, RN, R), pigment yellow L, benzidine yellow (G, GR), permanent yellow (NCG), vulcan fast yellow (5G, R), tartrazine lake, quinoline yellow lake, anthrazane yellow BGL, isoindolinone yellow, colcothar, minium, lead vermilion, cadmium red, cadmium mercury red, antimony vermilion, permanent red 4R, para red, fire red, para-chloro-ortho-nitroaniline red, lithol fast scarlet G, brilliant fast scarlet, brilliant carmine BS, permanent red (F2R, F4R, FRL, FRLL, F4RH), fast scarlet VD, vulcan fast rubine B, brilliant scarlet G, lithol rubin GX, permanent red F5R, brilliant carmine 6B, pigment scarlet 3B, bordeaux 5B, toluidine maroon, permanent bordeaux F2K, helio bordeaux BL, bordeaux 10B, BON maroon light, BON maroon medium, eosine lake, rhodamine lake B, rhodamine lake Y, alizarine lake, thioindigo red B, thioindigo maroon, oil red, quinacridone red, pyrazolone red, polyazo red, chrome vermilion, benzidine orange, perynone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine blue, Prussian blue, anthraquinone blue, fast violet B, methyl violet lake, cobalt violet, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc white, Litobon, and mixtures thereof. The amount of colorant used is generally between 0.1 and 50 parts by weight based on 100 parts by weight of binder resins.

The toner according to the present invention may comprise a charge control agent according to need. Any conventional charge control agent can be used. Examples thereof include nigrosine dye, triphenylmethane dye, chrome-containing complex dye, molybdate-chelated pigment, rhodamine dye, alkoxy amine, quaternary ammonium salt (including fluride-modified quaternary ammonium salt), alkylamide, phosphorous or phosphorous-containing compounds, tungsten or tungsten-containing compounds, fluorinated active agent, metal salicylate, and salicylate derivative metal salts.

The toner according to the present invention may comprise other additives. Examples of other additives include colloidal silica, hydrophobic silica, metal salts of fatty acids such as zinc stearate or aluminum stearate, metal oxides such as titanium oxide, aluminum oxide, tin oxide, or antimony oxide, and fluoropolymers.

The toner according to the present invention that is constituted by such materials may be used together with a carrier as a two-component developer. Alternatively, the toner may be mixed with a carrier and then used as a single-component developer. A carrier that is used herein is a conventional one such as iron powder, ferrite, or glass bead. A carrier may be coated with a resin. Examples of resin that is used include polyfluorocarbon, polyvinyl chloride, polyvinylidene chloride, phenol resin, polyvinyl acetal, and silicone resin. In general, the mixing ratio of the toner with a carrier is suitably about 0.5 to 6.0 parts by weight based on 100 parts by weight of the carrier.

In the present invention, the softening point (Sp) and the glass transition temperature (Tg) of polyol resin are measured in the following manner. A fully-automatic dropping point apparatus FP5/FP53 (Mettler) is used for measuring the softening point, and measurement is carried out in the following manner.

(1) The ground sample is placed in a melting pot, allowed to stand for 20 minutes, poured up to the upper end of a sample cup (dropping aperture: 6.35 mm), cooled to ordinary temperature, and mounted in a cartridge.

(2) A given temperature-rise rate (1° C./min) and the temperature at which measurement is initiated (to be set at 15° C. or lower than the anticipated softening point) are set in the FP-5 control unit. The cartridge is mounted in a FP-53 furnace, it is allowed to stand for 30 seconds, the start lever is pushed up, and measurement is then initiated (subsequent measurement is automatically carried out).

(3) The cartridge is removed upon completion of measurement.

(4) The softening point (° C.) is calculated in the following manner:
the value shown in the result display panel A of FP-5+correction value.

The sum of the obtained result and the aforementioned correction value is consistent with the results attained via the mercury method of Durran. When the difference between the value shown in the result display panel A and the temperature at which measurement is initiated (values shown on panels B and C) is not 15° C. or more, the test is performed again.

The epoxy equivalent weight of polyol resin was determined in accordance with the indicator titration method as indicated in JIS K 7236 4.2.

The toner according to the present invention can be produced via a variety of techniques, including conventional techniques. Examples of general techniques of production include the following:

(1) homogenous dispersion of resin, a charge control agent, a colorant, and optional additives with the use of a Henschel mixer;

(2) melt-kneading of the dispersion product with the use of a kneader, an extruder, a roll mill, or other means;

(3) coarse grinding of the kneaded product with the use of a hammer mill, a cutter mill, or other means, followed by fine grinding thereof with the use of a jet mill, a type 1 mill, or other means;

(4) classification of finely ground products with a dispersion type classifier, zigzag classifier, or other means; and

(5) dispersion of, for example, silica in the classified substance with the use of a Henschel mixer according to need.

As mentioned above, the toner according to the present invention can enhance tolerance to mechanical stress, inhibit toner aggregation or fusion, and exhibit improved durability via the use of polyester resin having a softening point and a glass transition temperature within the specified range (i.e., polyester resin having a low softening point but a high glass transition temperature) and application of particulate additives on toner particle surfaces.

Hereafter, the present invention is described in greater detail with reference to examples, although the technical scope of the present invention is not limited thereto as long as it is within the scope of the present invention. In the following examples and comparative examples, “parts” are by weight unless otherwise specified.

Synthesis of Polyester Resins and Physical Properties Thereof

Polyester resins 1 to 3 were synthesized using the materials shown in Table 1. The materials having the compositions as shown in Table 1 were placed in a glass three liter four-neck flask, a thermometer, a stainless stirrer, a reflux condenser, and a nitrogen inlet tube were mounted, and the reaction was allowed to proceed while stirring the contents of the flask under nitrogen stream in an electrically heated mantle at 200° C. and ordinary pressure in the first half of the process and at 220° C. and reduced pressure in the last half thereof. The progress of the reaction was observed while measuring the softening point, the reaction was terminated when the given level of physical properties was attained, and the reaction products were then cooled to room temperature to obtain polyester resins.

TABLE 1
Compositions of polyester resins 1 to 3

| | Alcohol component | | Acid component | | |
|---|---|---|---|---|---|
| Polyester No. | Diol A | Diol B | TPA | IDSA | TMAA |
| 1 | 1,420 | — | 670 | — | — |
| 2 | 1,420 | — | 670 | — | 60 |
| 3 | 710 | 650 | 500 | 270 | 100 |

In Table 1, alcohol and acid components are indicated by abbreviations and symbols, and they represent the following starting materials:

diol A: polyoxypropylene(2.2)-2,2-bis(4-hydroxyphenyl)propane

diol B: polyoxyethylene(2.2)-2,2-bis(4-hydroxyphenyl)propane

TPA: terephthalic acid

IDSA: isododecenylsuccinic acid

TMAA: trimellitic anhydride

The physical properties of polyester resins 1 to 3 are shown in Table 2.

TABLE 2
Physical properties of polyester resins 1 to 3

| Polyester | Softening point | Glass transition |
|---|---|---|
| No. | (° C.) | temperature (° C.) |
| 1 | 96 | 56 |
| 2 | 110 | 65 |
| 3 | 120 | 67 |

Synthesis of Polyester Resins 4 to 6 for Comparison and Physical Properties Thereof

The reaction was carried out in a manner identical to the above method for producing polyester resins, except for the use of the materials having compositions as shown in Table 3 below. The reaction was allowed to proceed while measuring the softening point, the reaction was terminated when the given level of physical properties was attained, and the reaction products were then cooled to room temperature to obtain polyester resins.

TABLE 3
Compositions of polyester resins 4 to 6

| | Alcohol component | | Acid component | | |
|---|---|---|---|---|---|
| Polyester No. | Diol A | Diol B | TPA | IDSA | TMAA |
| 4 | 1,420 | — | — | 470 | 60 |
| 5 | — | 1,440 | 560 | — | — |
| 6 | — | 1,440 | 560 | — | 400 |

In Table 3, alcohol and acid components are indicated by abbreviations and symbols, and they represent the same materials shown in Table 1. Values for the physical properties of these polyester resins are shown in Table 4.

TABLE 4
Values for physical properties of polyester resins 4 to 6

| Polyester | Softening point | Glass transition |
|---|---|---|
| No. | (° C.) | temperature (° C.) |
| 4 | 110 | 52 |
| 5 | 111 | 74 |
| 6 | 135 | 65 |

Preparation of Masterbatch

Masterbatch was prepared using the polyester resins shown above to result in a carbon black (CB, Nip 35, Degussa) content of 50% by weight with the use of a kneader and a two-roll mill.

TABLE 5
Production of masterbatch

| | | | CB | Are Sp and Tg within the | | |
|---|---|---|---|---|---|---|
| MB | PEs | CB | content | ranges represented by | Range of CB content | G′(100° C.) > |
| No. | resin | (type) | (%) | formulae (1) and (2)? | (specified in claim 2) | 10 + E3 |
| 1 | No. 1 | Nip 35 | 40 | ◯ | ◯ | ◯ |
| 2 | No. 2 | | | | | |
| 3 | No. 3 | | | | | |
| 4 | No. 4 | | | X | | |
| 5 | No. 5 | | | | | |
| 6 | No. 6 | | | | | |
| 7 | No. 1 | | 55 | ◯ | | |
| 8 | | | 25 | | | |
| 9 | | Nip 60 | 40 | | | |
| 10 | | Nip 90 | 30 | | | |
| 11 | | Nip 35 | 65 | | X | |
| 12 | | | 10 | | | |

Production Examples Of Polyol Resins

Polyol resins having the properties shown in Table 6 were produced. The softening points of crystalline polyesters used are shown in Table 7, and the types and the properties of the waxes are shown in Table 8.

TABLE 6
Production examples of polyol resins

| | | | | | Epoxy | | |
|---|---|---|---|---|---|---|---|
| PEPO | | Mw/ | Tg | Sp | equivalent | (A)/ | |
| No. | Mn | Mn | (° C.) | (° C.) | weight | parts | (B) |
| 1 | 4,200 | 6.2 | 61 | 120 | >20,000 | 20 | 38 |
| 2 | 5,200 | 7.5 | 63 | 130 | >20,000 | 25 | 48 |
| 3 | 3,300 | 6.5 | 61 | 118 | 1,750 | 25 | 48 |
| 4 | 3,600 | 4.3 | 59 | 112 | >20,000 | 25 | 48 |
| 5 | 5,500 | 7.8 | 63 | 133 | >20,000 | 30 | 58 |
| 6 | 4,700 | 5.0 | 62 | 118 | >20,000 | 2 | 4 |
| 7 | 3,600 | 3.5 | 58 | 110 | >20,000 | 20 | 38 |

(A) represents an alkylene oxide adduct (parts by weight) and (B) represents alkylene oxide adduct/epoxy resin×100.

TABLE 7
Softening points of crystalline polyesters

| Crystalline PEs | Softening point (° C.) |
|---|---|
| 1 | 110 |
| 2 | 85 |
| 3 | 135 |
| 4 | 150 |
| 5 | 30 |
| 6 | 175 |

TABLE 8
Physical properties of waxes

| | | Melting point | Penetration |
|---|---|---|---|
| Wax No. | Type | (° C.) | number |
| 1 | Synthetic ester | 105 | 1 |
| 2 | PE wax | 99 | 1 |
| 3 | Natural wax | 84 | 1 |
| 4 | Synthetic ester | 83 | 1 |
| 5 | Synthetic ester | 68 | 1 |
| 6 | Synthetic ester | 124 | 1 |

### EXAMPLES 1 To 7 AND COMPARATIVE EXAMPLES 1 TO 5

Toner was prepared using 80 parts of commercialized polyester resins for toner, 10 parts of crystalline polyester 1, and 10 parts of polyol 1 as binder resins, MB to a resulting CB content of 10%, a charge control agent (1 part, S-34, Orient Chemical Industries, Ltd.), a mold-releasing agent (1 part, PP wax), and a synthetic ester wax (1 part; melting point: 105° C.; penetration number: 1). These components were mixed, kneaded, and then ground. The surfaces of the ground products were treated to obtain the toner.

MB Nos. 1 to 12 were observed under a transmission electron microscope (TEM). This observation demonstrated that the dispersion states of MBs were satisfactory, except for MB No. 11.

The results of evaluating the toners prepared in Examples and Comparative own in Table 9.

TABLE 9
Results of toner evaluation (1)

| | | | | | | Fusing | Image quality | Aggregation and | |
|---|---|---|---|---|---|---|---|---|---|
| | | | Crystalline | Polyol | Result of TEM | and offset | (after printing | shelf life stability | Total |
| | Toner No. | MB No. | PEs No. | No. | observation | resistance | 10,000 images) | of developer | evaluation |
| Ex. 1 | 1 | 1 | 1 | 1 | ◯ | ◯ | ◯ | ◯ | ◯+++ |
| Ex. 2 | 2 | 2 | 1 | 1 | ◯ | ◯ | ◯ | ◯ | ◯+++ |
| Ex. 3 | 3 | 3 | 1 | 1 | ◯ | ◯ | ◯ | ◯ | ◯+++ |
| Comp. | 4 | 4 | 1 | 1 | ◯ | X | X | ◯ | ◯ |
| Ex. 1 | | | | | | | | | |
| Comp. | 5 | 5 | 1 | 1 | ◯ | X | X | ◯ | ◯ |
| Ex. 2 | | | | | | | | | |
| Comp. | 6 | 6 | 1 | 1 | ◯ | X | X | ◯ | ◯ |
| Ex. 3 | | | | | | | | | |
| Ex. 4 | 7 | 7 | 1 | 1 | ◯ | ◯ | ◯ | ◯ | ◯+++ |
| Ex. 5 | 8 | 8 | 1 | 1 | ◯ | ◯ | ◯ | ◯ | ◯+++ |
| Ex. 6 | 9 | 9 | 1 | 1 | ◯ | ◯ | ◯ | ◯ | ◯+++ |
| Ex. 7 | 10 | 10 | 1 | 1 | ◯ | ◯ | ◯ | ◯ | ◯+++ |
| Comp. | 11 | 11 | 1 | 1 | X | ◯ | X | ◯ | ◯ |
| Ex. 4 | | | | | | | | | |
| Comp. | 12 | 12 | 1 | 1 | ◯ | ◯ | X | ◯ | ◯ |
| Ex. 5 | | | | | | | | | |

Total evaluation:
Satisfactory [symbol] ◯+++ ◯++ ◯+ ◯ → Poor

### EXAMPLES 8 TO 19 AND COMPARATIVE EXAMPLES 6 TO 20

Toners were produced in the same manner as in Example 1, and the resulting toners were evaluated. The results of evaluating the toners produced in Examples and Comparative Examples are shown in Table 10. In Table 10, for example, “2/10 parts” in the “crystalline PEs No.” column indicates addition of 10 parts of crystalline PEs No. 2 shown in Table 7, “1/10 parts” in the “polyol No.” column indicates addition of 10 parts of polyol No. 1 shown in Table 6, and “No. 1/1 part” in the “wax” column indicates addition of 1 part of wax No. 1 shown in Table 8.

TABLE 10
Results of toner evaluation (2)

| | | | | | | Fusing | Image quality | Coagulation and | |
|---|---|---|---|---|---|---|---|---|---|
| | Toner | MB | Crystalline | | | and offset | (after printing | shelf life stability | Total |
| | No. | No. | PEs No. | Polyol No. | Wax | resistance | 10,000 images) | of developer | evaluation |
| Ex. 8 | 13 | 1 | 2/10 parts | 1/10 parts | No. 1/1 part | ◯ | ◯ | ◯ | ◯+++ |
| Ex. 9 | 14 | | 3/10 parts | | | ◯ | ◯ | ◯ | ◯+++ |
| Ex. 10 | 15 | | 4/10 parts | | | ◯ | ◯ | ◯ | ◯+++ |
| Ex. 11 | 16 | | 1/10 parts | 2/10 parts | | ◯ | ◯ | ◯ | ◯+++ |
| Ex. 12 | 17 | | | 1/10 parts | No. 2/1 part | ◯ | ◯ | ◯ | ◯+++ |
| Ex. 13 | 18 | | | | No. 3/1 part | ◯ | ◯ | ◯ | ◯+++ |
| Ex. 14 | 19 | | | | No. 4/1 part | ◯ | ◯ | ◯ | ◯+++ |
| Ex. 15 | 20 | | | | No. 1/6 parts | ◯ | ◯ | ◯ | ◯+++ |
| Ex. 16 | 21 | | 1/5 parts | | No. 1/1 part | ◯ | ◯ | ◯ | ◯+++ |
| Ex. 17 | 22 | | 1/30 parts | | | ◯ | ◯ | ◯ | ◯+++ |
| Ex. 18 | 23 | | 1/10 parts | 1/5 parts | | ◯ | ◯ | ◯ | ◯+++ |
| Ex. 19 | 24 | | | 1/40 parts | | ◯ | ◯ | ◯ | ◯+++ |
| Comp. | 25 | 1 | None | 1/10 parts | No. 1/1 part | ◯ | XX | ◯ | ◯ |
| Ex. 6 | | | | | | | | | |
| Comp. | 26 | | 1/50 parts | | | ◯ | X | X | ◯ |
| Ex. 7 | | | | | | | | | |
| Comp. | 27 | | 1/10 parts | | None | ◯ | Δ | Δ | ◯+ |
| Ex. 8 | | | | | | | | | |
| Comp. | 28 | | | | No. 1/10 parts | ◯ | X | X | ◯ |
| Ex. 9 | | | | | | | | | |
| Comp. | 29 | | 5/10 parts | | No. 1/1 part | ◯ | X | X | ◯ |
| Ex. 10 | | | | | | | | | |
| Comp. | 30 | | 6/10 parts | | | ◯ | X | ◯ | ◯ |
| Ex. 11 | | | | | | | | | |
| Comp. | 31 | | 1/10 parts | 3/10 parts | | ◯ | X | X | ◯ |
| Ex. 12 | | | | | | | | | |
| Comp. | 32 | | | 4/10 parts | | ◯ | X | X | ◯ |
| Ex. 13 | | | | | | | | | |
| Comp. | 33 | | | 5/10 parts | | ◯ | Δ | X | ◯ |
| Ex. 14 | | | | | | | | | |
| Comp. | 34 | | | 6/10 parts | | ◯ | Δ | X | ◯ |
| Ex. 15 | | | | | | | | | |
| Comp. | 35 | | | 7/10 parts | | ◯ | X | X | ◯ |
| Ex. 16 | | | | | | | | | |
| Comp. | 36 | | | None | | ◯ | Δ | Δ | ◯+ |
| Ex. 17 | | | | | | | | | |
| Comp. | 37 | | | 1/50 parts | | ◯ | X | X | ◯ |
| Ex. 18 | | | | | | | | | |
| Comp. | 38 | | | 1/10 parts | No. 5/1 part | ◯ | X | X | ◯ |
| Ex. 19 | | | | | | | | | |
| Comp. | 39 | | | | No. 6/1 part | ◯ | X | ◯ | ◯+ |
| Ex. 20 | | | | | | | | | |
| Comp. | 40 | 4 | | None | No. 1/1 part | ◯ | X | X | ◯ |
| Ex. 21 | | | | | | | | | |
| Comp. | 41 | | 5/10 parts | 1/10 parts | None | ◯ | X | X | ◯ |
| Ex. 22 | | | | | | | | | |
| Comp. | 42 | | | | No. 1/10 parts | ◯ | X | XX | ◯ |
| Ex. 23 | | | | | | | | | |

### INDUSTRIAL APPLICABILITY

The masterbatch according to the present invention comprises a colorant such as carbon black (CB) with good dispersibility, and toner using such masterbatch can produce images with excellent quality.

1. Masterbatch (MB) comprising at least a colorant and polyester resin, wherein the glass transition temperature (Tg) and the softening point (Sp) of said polyester resin satisfy the correlations defined by formulae (1) and (2):
4Tg−170≦Sp≦4Tg−110 (1); and
90≦Sp≦120 (2).

2. The masterbatch (MB) according to claim 1, wherein the storage modulus (G′) at 100° C. is 10E+3 or higher and the ratio of a colorant to resin is between 25:75 and 55:45.

3. Toner using the masterbatch according to claim 1 or 2.

4. The toner according to claim 3 comprising polyol resins synthesized via reactions of crystalline polyester resins having a softening point of 80° C. to 150° C., epoxy resins (a), dihydric phenol (b), and an alkylene oxide adduct of dihydric phenol or a glycidyl ether compound thereof (c), having a polyoxyalkylene moiety in its main chain, and having the ratio of the weight average molecular weight to the number average molecular weight (Mw/Mn) of 4 to 10.

5. The toner according to claim 4, wherein said polyol resins comprise 10 to 40 parts by weight of component (c) based on the total amount thereof (100 parts by weight).

6. The toner according to claim 4, wherein component (a) is comprised of at least 2 types of bisphenol epoxy resins having different number average molecular weights (Mn).

7. The toner according to claim 4, wherein the epoxy equivalent weight of said polyol resins is 20,000 or higher.

8. The toner according to claim 4, wherein the softening point of said polyol resins is between 115° C. and 130° C.

9. The toner according to claim 4, wherein the amount of component (c) is 10 to 50 parts by weight based on 100 parts by weight of component (a) in polyol resins.

10. The toner according to claim 4, wherein the melting point of a mold-releasing agent contained in said toner is between 70° C. and 120° C.
